(19) United States
(12) Patent Application Publication
(10) Pub. No.: US 2011/0103612 A1
(43) Pub. Date: May 5, 2011

(54) Indoor Sound Receiving System and Indoor Sound Receiving Method

(75) Inventors: Yang-Ming Chou, Luodong Township (TW); Shyang-Jye Chang, Xindian City (TW); Yung-Yu Chen, Xinyuan Township (TW)

(73) Assignee: INDUSTRIAL TECHNOLOGY RESEARCH INSTITUTE, Hsinchu (TW)

(21) Appl. No.: 12/917,844

(22) Filed: Nov. 2, 2010

(30) Foreign Application Priority Data
Nov. 3, 2009 (TW) 98137336

(51) Int. Cl. H04R 3/00

(52) U.S. Cl. 381/92

(57) ABSTRACT

An indoor sound receiving system and an indoor sound receiving method are provided. The indoor sound receiving system comprises a microphone array, a path function database, a sound tracking unit, a path function selecting unit and a signal processing unit. The microphone array senses at least one primary sound source to output a plurality of microphones sensing signals. The path function database stores a plurality of sets of path functions. The sound tracking unit locates a primary sound source region according to a plurality of microphones sensing signals. The path function selecting unit selects a set of path functions corresponding to the primary sound source region as a set of primary sound source path functions from the path function database. The signal processing unit executes an audio enhancement process to output an enhanced speech signal according to the set of primary sound source path functions and the microphone sensing signals.

This application claims the benefit of Taiwan application Serial No. 98137336, filed Nov. 3, 2009, the subject matter of which is incorporated herein by reference.

### BACKGROUND

1. Technical Field

The disclosure relates in general to a sound receiving system and a sound receiving method, and more particularly to an indoor sound receiving system and an indoor sound receiving method.

2. Description of the Related Art

For a media-rich life, people need one of versatile and different kinds of communication media including audio, video, images and texts. especially, the audio and video media are used mostly. Thus, many indoor communications products, such as video conference system and audio conference system are provided. No matter what kinds of the conference systems, absolutely, the sound, especially voices are important things that should be considered.

However, some conference systems, including the fixed directional microphone array and the noise reduction algorithm, just can reduce noises in some fixed direction and cannot adaptively point out which direction the sound come from. Thus, the flexibility, the convenience and the clearness of sound receiving are affected.

### SUMMARY

The disclosure is directed to an indoor sound receiving system and an indoor sound receiving method.

According to the first aspect of the above disclosure, an indoor sound receiving system is provided. The indoor sound receiving system comprises a microphone array, a path function database, a sound tracking unit, a path function selecting unit and a signal processing unit. The microphone array senses at least one primary sound source to output a plurality of microphones sensing signals. The path function database stores a plurality of sets of path functions. The sound tracking unit locates a primary sound source region according to the signals of the microphone array. The path function selecting unit selects and uses a set of path functions corresponding to the primary sound source region as a set of primary sound source path functions from the path function database. The signal processing unit executes an audio enhancement process to output an enhanced speech signal according to the set of primary sound source path functions and the microphone sensing signals.

According to the second aspect of the above disclosure, an indoor sound receiving method used in an indoor sound receiving system is provided. The indoor sound receiving system comprises a microphone array, which comprises a plurality of microphones respectively disposed in some positions of a room. The indoor sound receiving method at least comprises the following steps: Firstly, at least one primary sound source is sensed by a plurality of microphones of the microphone array to output a plurality of microphones sensing signals. Next, the position of the primary sound source is located as a primary sound source region from a plurality of regions of an indoor space according to a plurality of microphones sensing signals. Then, a set of path functions corresponding to the primary sound source region is selected as a set of primary sound source path functions from a plurality of sets of path functions corresponding to a plurality of regions respectively. Lastly, an audio enhancement process is executed to output an enhanced speech signal according to the set of primary sound source path functions and a plurality of microphones sensing signals.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 shows an indoor sound receiving system;

FIG. 2 shows a flowchart of an indoor sound receiving method;

FIG. 3 shows a process of locating a primary sound source region from a plurality of regions (24 regions are exemplified in the diagram);

FIG. 4 shows a detailed block diagram of a portion of one indoor sound receiving system;

FIG. 5 shows a detailed block diagram of other portion of the indoor sound receiving system; and

FIG. 6 shows a path function generating unit.

### DETAILED DESCRIPTION

An indoor sound receiving system and an indoor sound receiving method are disclosed in a exemplary embodiment below. The indoor sound receiving system comprises a microphone array, a path function database, a sound tracking unit, a path function selecting unit and a signal processing unit. The microphone array comprises a plurality of microphones respectively disposed in a plurality of positions of an indoor space. The said microphones sense at least one primary sound source to output a plurality of microphones sensing signals. The path function database stores a plurality of sets of path functions corresponding to the said positions respectively. The sound tracking unit locates position of the primary sound source from a plurality of regions according to a plurality of microphones sensing signals. The path function selecting unit selects a set of path functions corresponding to the primary sound source region from a plurality of sets of path functions. The signal processing unit executes an audio enhancement process to output an enhanced speech signal according to the set of primary sound source path functions and a plurality of microphones sensing signals.

The indoor sound receiving method used in an indoor sound receiving system at least comprises the following steps: Firstly, at least one primary sound source is sensed from a plurality of microphones of the microphone array to output a plurality of microphones sensing signals. Next, the position of the primary sound source is located from a plurality of regions of an indoor space according to a plurality of microphones sensing signals. Then, a set of path functions corresponding to the primary sound source region is selected from a plurality of sets of path functions corresponding to a plurality of regions respectively. Lastly, an audio enhancement process is executed to output an enhanced speech signal according to the set of primary sound source path functions and a plurality of microphones sensing signals.

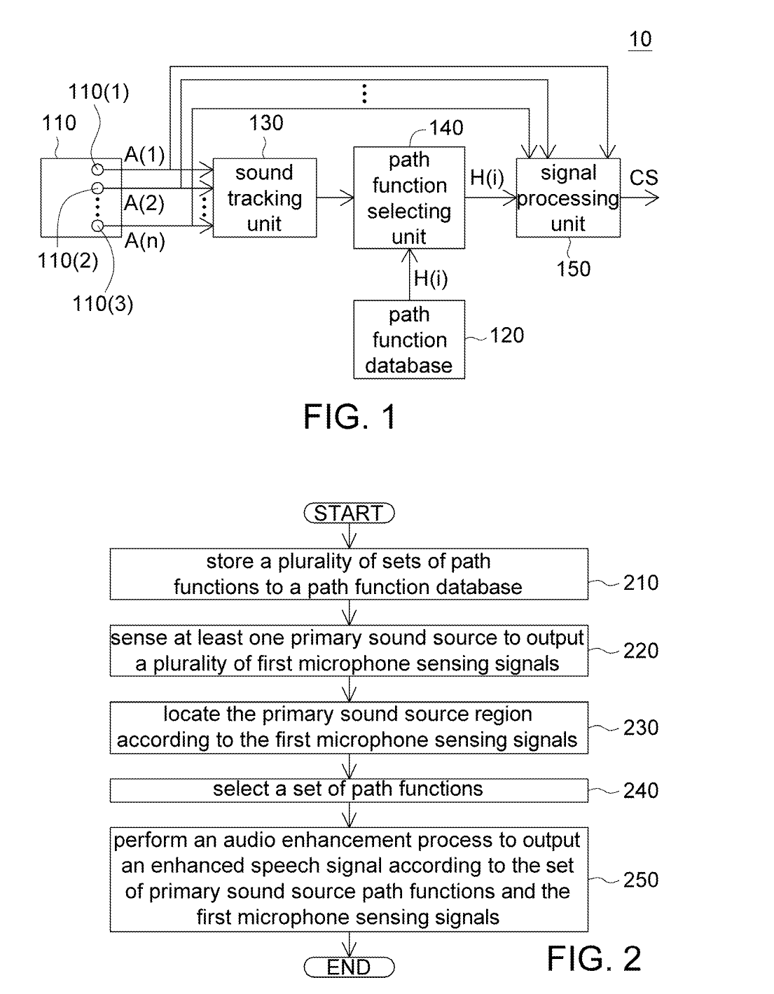

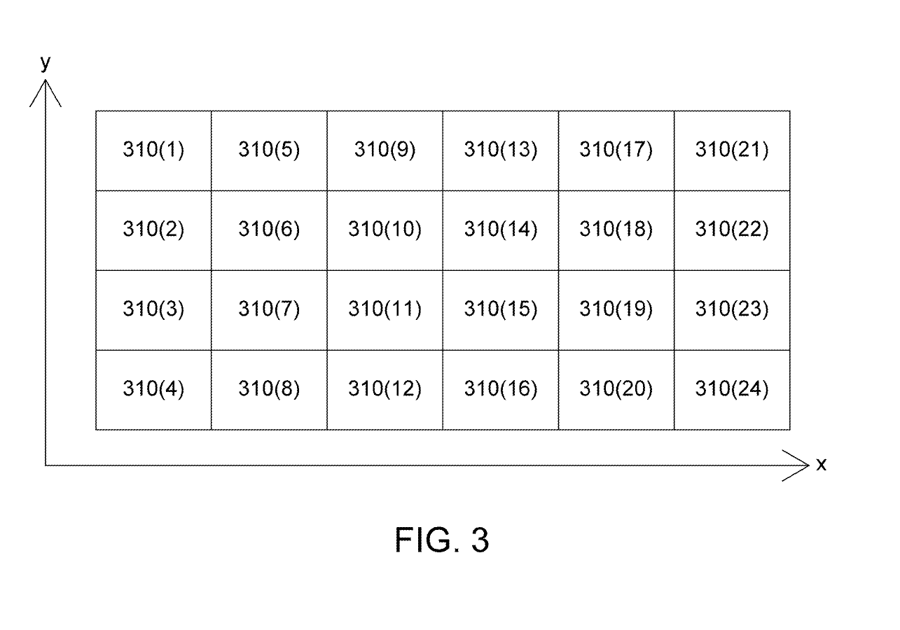

Referring to FIG. 1˜FIG. 3. FIG. 1 shows an indoor sound receiving system. FIG. 2 shows a flowchart of an indoor sound receiving method. FIG. 3 shows a process that can determine the location of a primary sound source region from a plurality of positions. The precision that can locate the sound source position exactly is based on the number of the regions that can be divided. For example, both of the precision of the x-axis and y-axis is 30 degrees. Since each can denote 6 directions, 6*6=36 regions can be formed, wherein 24 regions are exemplified in FIG. 3. The indoor sound receiving method is used in an indoor sound receiving system 10. The indoor sound receiving system 10 comprises a microphone array 110, a path function database 120, a sound tracking unit 130, a path function selecting unit 140 and a signal processing unit 150. The microphone array 110, which can be realized by a two-dimensional array of microphones or a three-dimensional array of microphones, comprises microphones 110(1)˜110(n) respectively disposed in n regions of an indoor space. The microphones 110(1)˜110(n) can be realized by Omni-directional microphones, which are cheaper than directional microphones and can reduce the cost. The microphones 110(1)˜110(n) can be disposed on the ceiling, the walls or the conference table for a two-dimensional arrangement or a three-dimensional arrangement. The path function database 120 is used for storing the n sets of path functions respectively corresponding to the said n regions.

The indoor sound receiving method comprises the following steps. Firstly, the method begins at Step 210, the path functions of each region are stored in a path function database. Next, the method proceeds to Step 220, at least one primary sound source is sensed by the microphones 110(1)˜110(n) to output a plurality of first microphone sensing signals A(1)˜A(n). Then, the method proceeds to Step 230, the position of the primary sound source is located from n regions by the sound tracking unit 130 according to a plurality of microphone sensing signals A(1)˜A(n). The sound tracking unit 130 such as executes time domain cross correlation (TDCC) algorithm or speaker localization algorithm to locate the primary sound source region.

According to TDCC algorithm, the time delay is obtained by using the correlation among the signals of different microphones in time domain. After a microphone sensing signal is received by two microphones, the time delay with the largest correlation is calculated by TDCC algorithm, and lastly, the sound source azimuth angle is obtained from the obtained time delay, the distance between microphones, and the speed of the sound.

According to the speaker localization algorithm, the fast Fourier transform (FFT) is applied to the signal received by the microphones; the energy of each microphone in the frequency domain is calculated; and lastly, the direction with the largest sum of energy is located as the direction of the sound source in the space.

For example, the said indoor space can be divided into 24 regions 310(1)˜310(24), and the said microphone array is realized by a two-dimensional array of microphones. The sound tracking unit 130 calculates the intersection of the incoming angles of the sound source according to the microphones in the x-axis and the y-axis. The region 310(14) in which the intersection of the incoming angles of the sound source is identified as the primary position.

Then, the method proceeds to step 240, a set of path functions corresponding to the primary sound source region is selected as a set of primary sound source path functions H(i) from n sets of path functions stored in the path function database 120 to the path function selecting unit 140. Lastly, the method proceeds to step 250, an audio enhancement process is executed by the signal processing unit 150 to output an enhanced speech signal CS according to the set of primary sound source path function H(i) selected by the path function selecting unit 140 and the first microphone sensing signals A(1)˜A(n). By this way, the voice message transmitted will not be distorted, and the sound received in a remote end, such as a conference room, is still clear.

Since the indoor sound receiving system 10 executes an audio enhancement process according to the situated region of the primary sound source, an adaptive directional sound receiving process can be applied according to the current direction of the user, and it can clearly recognize the sound sources at different distances in the same direction. By this way, the sound receiving quality will not be affected even when the speaker walks and talks.

Also, the microphones of the indoor sound receiving system 10 are not necessarily disposed on the conference table, and can also be disposed on the ceiling or the walls according to the needs. Thus, the indoor sound receiving system 10 of the disclosure does not limit on the desk or tables and allows the speaker not to hold a microphone in hand. Moreover, the user does not have to raise sound volume in order to enhance the sound receiving effect.

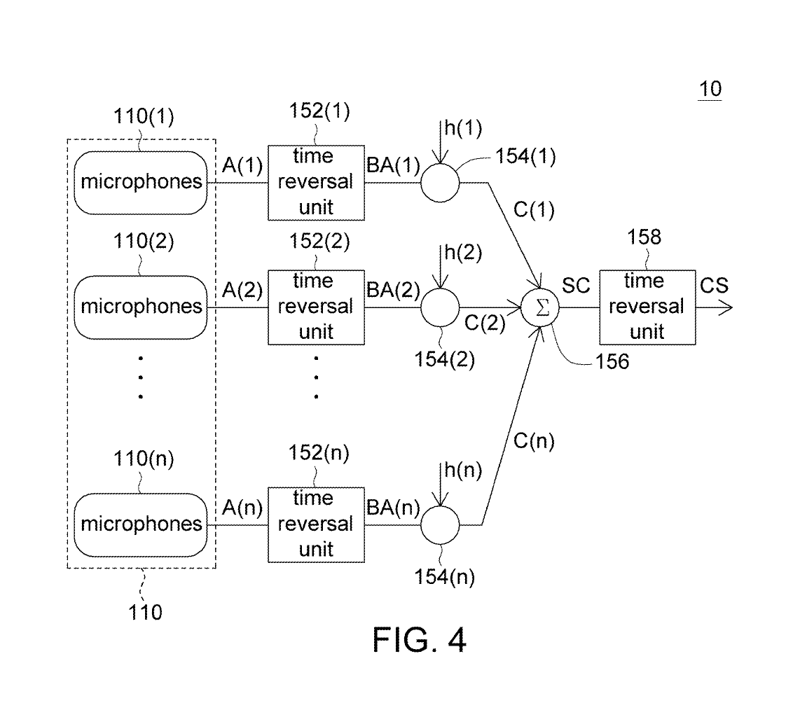

Referring to FIG. 4, a detailed block diagram of one portion of an indoor sound receiving system is shown. The set of primary sound source path functions H(i) selected by the path function selecting unit 140 further comprises path functions h(1)˜h(n). The signal processing unit 150 comprises time reversal units 152(1)˜152(n), convolution units 154(1)˜154(n), an adder 156 and the time reversal 158. The time reversal units 152(1)˜152(n) are used for performing the time reversal method to the first microphone sensing signals A(1)˜A(n) respectively to output the time reversal signals BA(1)˜BA(n). The convolution units 154(1)˜154(n) are used to output the convolution signals C(1)˜C(n) respectively according to the time reversal signal BA(1)˜BA(n) and the path function h(1)˜h(n). The adder 156 adds up the convolution signals C(1)˜C(n) to output a superposition focusing signal SC. The time reversal unit 158 applies time reversal to the superposition result SC and then outputs an enhanced speech signal CS.

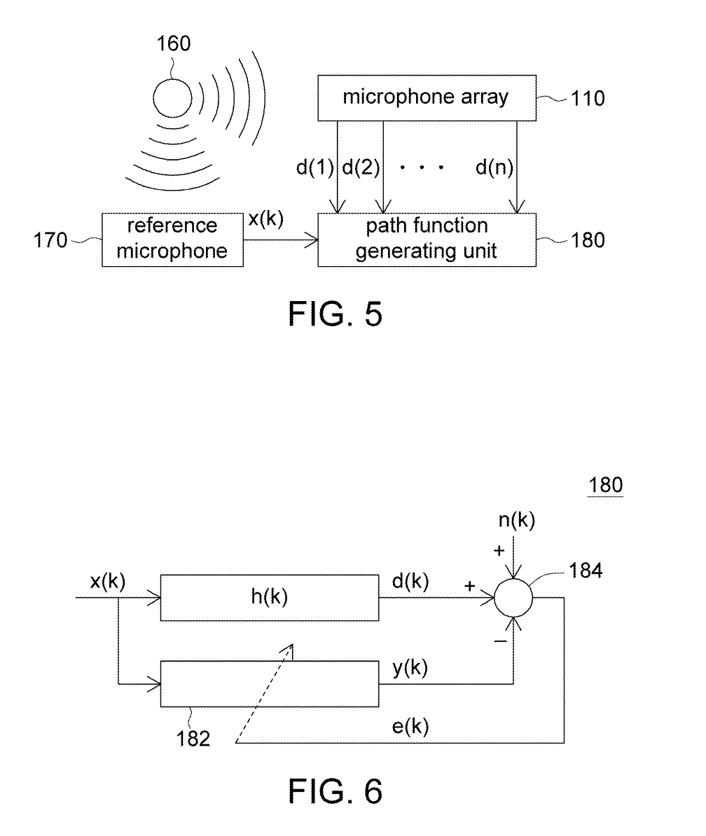

Referring to FIG. 5, a detailed block diagram of another portion of the indoor sound receiving system is shown. The indoor sound receiving system 10 may further comprises a broadband sound source player 160, a reference microphone 170 and a path function generating unit 180. The sound source player 160 and the reference microphone 170 are disposed in one of the n regions. The broadband sound source player 160 provides a broadband sound source, then the microphone array 110 senses the broadband sound source to output the second microphone sensing signals d(1)˜d(n). The reference microphone 170 senses the broadband sound source to output a reference signal R. The path function generating unit 180 generates a set of path functions corresponding to the position of the reference microphone 170 and the broadband sound source player 160 according to the reference signal R and the second microphone sensing signals d(1)˜d(n). Likewise, the sound source player 160 and the reference microphone 170 can be sequentially disposed in n regions, such that the path function generating unit 180 generates n sets of path functions corresponding to n regions.

Referring to FIG. 6, a path function generating unit is shown. The path function generating unit 180 comprises an adaptive filter 182 and a computation unit 184. The adaptive filter 182 executes some algorithms, such as, the least mean square (LMS) algorithm, the normalized least mean square (NLMS) algorithm or the recursive least squares (RLS) algorithm to output a filter output signal y(k) according to the reference signal x(k) outputted by the said reference microphone 170 and the error value e(k).

The computation unit 184, which can be realized by a subtractor, outputs an error value e(k) according to the second microphone sensing signal d(k), the filter output signal y(k) and the noise signal n(k), wherein k=1˜n. When the error value e(k) is smaller than a predetermined threshold, the adaptive filter 182 obtains a set of path functions corresponding to the position of the reference microphone 170 and the broadband sound source player 160.

The indoor sound receiving system and the indoor sound receiving method disclosed in the above embodiments of the disclosure have many advantages exemplified below:

Firstly, the indoor sound receiving system and the indoor sound receiving method of the disclosure are capable of recognizing several sound sources at different distances in the same direction.

Secondly, the indoor sound receiving system and the indoor sound receiving method of the disclosure can do without expensive directional microphones.

Thirdly, the indoor sound receiving system and the indoor sound receiving method of the disclosure prevent the voice message transmitted from being distorted, and make sound received in a remote end, such as a conference room, still clear.

Fourthly, the indoor sound receiving system and the indoor sound receiving method of the disclosure apply an adaptive directional sound receiving process and provide well-quality sound receiving even when the speaker walk and talk.

Fifthly, the microphone does not limit on the desk or table and makes the speaker to be hand free when the user is speaking, and the user does not need to raise his/her voice volume in order to enhance sound receiving.

While the disclosure has been described by way of example and in terms of the disclosed embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An indoor sound receiving system, comprises:
a microphone array, comprising:
a plurality of microphones respectively disposed in a plurality of regions of an indoor space, wherein the microphones sense at least one primary sound source to output a plurality of first microphone sensing signals;
a path function database used for storing a plurality of sets of path functions respectively corresponding to the regions;
a sound tracking unit used for locating the situated region of the primary sound source as a primary sound source region from the regions according to the first microphone sensing signals;
a path function selecting unit used for selecting a set of path functions corresponding to the primary sound source region as a set of primary sound source path functions from the sets of path functions; and
a signal processing unit used for executing an audio enhancement process to output an enhanced speech signal according to the set of primary sound source path functions and the first microphone sensing signals.

2. The indoor sound receiving system according to claim 1, wherein the signal processing unit comprises:
a plurality of first time reversal units used to execute time reversal method to the first microphone sensing signals respectively to output a plurality of time reversal signals;
a plurality of convolution units used to output a plurality of convolution signals respectively according to the time reversal signals and the set of primary sound source path functions;
an adder used to add up the convolution signals to output a focusing signal using superposition method; and
a second time reversal unit used to execute time reversal method to the focusing signal and then output the enhanced speech signal.

3. The indoor sound receiving system according to claim 1, further comprising:
a broadband sound source player used for providing a broadband sound source, wherein the microphone array senses the broadband sound source to output a plurality of the second microphone sensing signals;
a reference microphone disposed in one of the regions with the broadband sound source player and used for sensing the broadband sound source to output a reference signal; and
a path function generating unit used for generating a set of path functions corresponding to the positions of the reference microphone and the broadband sound source player according to the reference signal and the second microphone sensing signals.

4. The indoor sound receiving system according to claim 3, wherein the path function generating unit comprises:
an adaptive filter used to output a filter output signal according to the reference signal; and
a computation unit used to output an error value according to the microphone sensing signals and the filter output signal, wherein when the error value is smaller than a predetermined threshold, the adaptive filter obtains the set of path functions corresponding to the positions of the reference microphone and the broadband sound source player.

5. The indoor sound receiving system according to claim 4, wherein the adaptive filter executes least mean square (LMS) algorithm to obtain the set of path functions corresponding to the positions of the reference microphone and the broadband sound source player according to the reference signal and the error value.

6. The indoor sound receiving system according to claim 4, wherein the adaptive filter executes a normalized least mean square (NLMS) algorithm to obtain the set of path functions corresponding to the positions of the reference microphone and the broadband sound source player according to the reference signal and the error value.

7. The indoor sound receiving system according to claim 4, wherein the adaptive filter executes recursive least squares (RLS) algorithm to obtain the set of path functions corresponding to the positions of the reference microphone and the broadband sound source player according to the reference signal and the error value.

8. The indoor sound receiving system according to claim 1, wherein the microphone array is realized by a two-dimensional array of microphones.

9. The indoor sound receiving system according to claim 1, wherein the microphone array is realized by a three-dimensional array of microphones.

10. The indoor sound receiving system according to claim 1, wherein the microphones are realized by omni-directional microphones.

11. The indoor sound receiving system according to claim 1, wherein the sound tracking unit executes time domain cross correlation (TDCC) algorithm according to the first microphone sensing signals locates the primary sound source region.

12. The indoor sound receiving system according to claim 1, wherein the sound tracking unit executes speaker localization algorithm to locate the primary sound source region according to the first microphone sensing signals.

13. An indoor sound receiving method used in an indoor sound receiving system, wherein the indoor sound receiving system comprises a microphone array comprising a plurality of microphones respectively disposed in a plurality of regions of an indoor space, and the indoor sound receiving method comprises:
sensing at least one primary sound source by the microphones to output a plurality of first microphone sensing signals;
locating the position of the primary sound source as a primary sound source region from the regions according to the first microphone sensing signals;
selecting a set of path functions corresponding to the primary sound source region as a set of primary sound source path functions from a plurality of sets of path functions respectively corresponding to the regions; and
performing an audio enhancement process to output an enhanced speech signal according to the set of primary sound source path functions and the first microphone sensing signals.

14. The indoor sound receiving method according to claim 13, wherein the step of outputting an enhanced speech signal comprises:
performing time reversal to the first microphone sensing signals respectively to output a plurality of time reversal signals;
outputting a plurality of convolution signal respectively according to the time reversal signals and the set of primary sound source path functions;
adding up the convolution signals to output a focusing signal; and
performing time reversal to the focusing signal and then outputting the enhanced speech signal.

15. The indoor sound receiving method according to claim 13, further comprising:
providing a broadband sound source, so that the microphone array senses the broadband sound source to output a plurality of the second microphone sensing signals;
providing a reference microphone to sense the broadband sound source to output a reference signal, wherein the reference microphone and the broadband sound source player are disposed in one of the regions; and
generating a set of path functions corresponding to the positions of the reference microphone and the broadband sound source player according to the reference signal and the second microphone sensing signals.

16. The indoor sound receiving method according to claim 15, wherein the step of generating a set of path functions corresponding to the positions of the reference microphone and the broadband sound source player comprises:
providing an adaptive filter to output a filter output signal according to the reference signal; and
outputting an error value according to the second microphone sensing signals and the filter output signal, wherein when the error value is smaller than a predetermined threshold, the adaptive filter obtains the set of path functions corresponding to the positions of the reference microphone and the broadband sound source player.

17. The indoor sound receiving method according to claim 16, wherein the adaptive filter executes least mean square (LMS) algorithm according to the reference signal and the error value to obtain the set of path functions corresponding to the positions of the reference microphone and the broadband sound source player.

18. The indoor sound receiving method according to claim 16, wherein the adaptive filter executes normalized least mean square (NLMS) algorithm according to the reference signal and the error value to obtain the set of path functions corresponding to the positions of the reference microphone and the broadband sound source player.

19. The indoor sound receiving method according to claim 16, wherein the adaptive filter executes recursive least squares (RLS) algorithm according to the reference signal and the error value to obtain the set of path functions corresponding to the positions of the reference microphone and the broadband sound source player.

20. The indoor sound receiving method according to claim 13, wherein the microphone array is realized by a two-dimensional array of microphones.

21. The indoor sound receiving method according to claim 13, wherein the microphone array is realized by a three-dimensional array of microphones.

22. The indoor sound receiving method according to claim 13, wherein the microphones are realized by omni-directional microphones.

23. The indoor sound receiving method according to claim 13, wherein the step of locating the position of the primary sound source as a primary sound source region executes time domain cross correlation (TDCC) algorithm to locate the primary sound source position according to the first microphone sensing signals.

24. The indoor sound receiving method according to claim 13, wherein the step of locating the position of the primary sound source as a primary sound source region executes speaker localization algorithm to locate the primary sound source position according to the first microphone sensing signals.
